(19) United States
(12) Patent Application Publication
(10) Pub. No.: US 2026/0049553 A1
(43) Pub. Date: Feb. 19, 2026

(54) FEEDER POLE APPARATUS, METHOD OF USE AND MANUFACTURE THEREOF

(71) Applicant: Innovative Blasting Technologies PTY LTD, Leschenault (AU)

(72) Inventors: Jollan Kingsley, Leschenault (AU); Glenn Bennett, Rivervale (AU)

(21) Appl. No.: 19/105,161

(22) PCT Filed: Oct. 6, 2023
(86) PCT No.: PCT/AU2023/050976

§ 371 Date: Feb. 20, 2025

(30) Foreign Application Priority Data
Oct. 9, 2022 (AU) 2022902942

(51) Int. Cl. E21D 9/00

(52) U.S. Cl. CPC E21D 9/003; E21D 9/006

(57) ABSTRACT

A feeder pole apparatus for blast hole surveying, the feeder pole comprising: a tubular member having a first end and a second end; a handle portion connectable to the tubular member adjacent to the first end. A nozzle having a tip and a base with an opening, wherein the opening of the base is connectable to the second end of the tubular member; the nozzle comprising a side wall aperture positioned on a side wall of the nozzle, and an elongate slot joining the side wall aperture to the nozzle tip.

### TECHNICAL FIELD

The present invention relates to a feeder pole apparatus, method for use and manufacture thereof. More particular, the present invention relates to a feeder pole for hole surveying techniques within underground mining, specifically targeting the surveying of upward-oriented holes without the need for elevated work platforms.

### BACKGROUND

In underground mining, a key step to the extraction process is the drilling of blastholes, loading them with explosives and blasting and fragmenting the rock so that it can be bogged and hauled to the surface. When drilling blast holes, there is a necessity for the holes to be accurately drilled, as inaccurately drilled blast holes can lead to undesirable outcomes such as overbreak, underbreak, poor fragmentation and sub optimal blasting.

It is common practice to survey blast holes to ensure that the holes have been drilled accurately enough to ensure safe and effective blasting with minimal overbreak and underbreak. Hole surveying of up holes is often inconvenient, and an elevated work platform is required to allow a hole survey technician to access the collar of the hole due to it being located in the ceiling (backs) of the underground tunnel.

In the context of underground mining operations, a pivotal phase in the extraction process involves the precise drilling of blastholes, subsequently loading them with explosives for controlled blasting and efficient fragmentation of rock formations. This fragmentation enables the excavation and removal of loosened material to the surface. Ensuring accuracy during the drilling of blast holes is paramount, as any deviations from the intended placement can result in unfavourable outcomes such as overbreak, underbreak, suboptimal fragmentation, and compromised blasting efficiency.

Currently, a prevalent approach to address this concern involves conducting surveys of blast holes. These surveys serve the purpose of confirming the accuracy of hole drilling, thereby facilitating safe and effective blasting with minimal instances of overbreak and underbreak. However, surveying blast holes that are oriented upwards poses challenges. Accessing the collar of such up holes situated in the ceiling (backs) of underground tunnels necessitates the use of elevated work platforms, a process that is both inconvenient and resource-intensive. This method often relies on equipment like integrated tool carriers with attached work baskets for access.

To mitigate these limitations and streamline the process of surveying up holes without the dependency on elevated work platforms or additional equipment, there arises a pressing need for an innovative solution which should enable unimpeded hole surveying while maintaining safety and efficiency. The development of the feeder pole addresses this requirement with significant merit. By eliminating the requirement for heavy machinery to facilitate access to blast holes, the feeder pole emerges as a pivotal advancement.

Any discussion of the prior art throughout the specification should in no way be considered as an admission that such prior art is widely known or forms part of common general knowledge in the field.

### SUMMARY

### Problems to be Solved

It is an advantage to provide a method and means for surveying up holes without the requirement of an elevated work platform if hole surveying is to be performed unimpeded and without relying on other resources such as integrated tool carrier with work basket attachment.

It is another advantage to provide a feeder pole that don't need to use heavy machinery in assisting with access to blast holes.

It is another advantage to provide a feeder pole that can also be used for other applications that are related to blast holes such as and not limited to: prep hose for cleaning and charging blast holes, and optical solutions like cameras as well as other sensing equipment that requires access to the holes from the ground.

It is an advantage to provide a feeder pole that services as a multi-purpose tool for various applications closely associated with blast holes. For instance, it can be employed to prepare holes for tasks such as cleaning and charging blast holes.

It is an advantage to provide a feeder pole that is adaptable to various related tasks that underscores its significance in optimizing multiple facets of blast hole operations.

It is an object of the present invention to overcome or ameliorate at least one of the disadvantages of the prior art, or to provide a useful alternative.

### Means for Solving the Problem

At is core, the invention aims to revolutionize the hole surveying process by introducing an innovative apparatus and method that eliminates the necessity for elevated work platforms. This advancement enhances the safety, efficiency, and accessibility of hole surveying operations.

A first aspect of the present invention may relate to a feeder pole apparatus for blast hole surveying, the feeder pole comprising: a tubular member having a first end and a second end; a handle portion connectable to the tubular member adjacent to the first end, and a nozzle having a tip and a base with an opening, wherein the opening of the base is connectable to the second end of the tubular member; the nozzle comprising a side wall aperture positioned on a side wall of the nozzle, and an elongate slot joining the side wall aperture to the nozzle tip.

Preferably, the tubular member comprises a first tube having a lower end and an upper end, and a second tube having a lower end and an upper end, wherein the first tube defines a receiving space from the lower end to the upper end; the second tube receivable in the receiving space of the first tube, wherein the lower end of the second tube is securable to the upper end of the first tube.

Preferably, the nozzle has a nozzle base at one end and a nozzle tip at the other end, wherein the nozzle base is secured to the upper end of the second tube.

Preferably, the nozzle base tapers to a middle portion between the nozzle base and the nozzle tip.

Preferably, the side wall aperture is positioned between the nozzle base and the middle portion of the nozzle.

Preferably, the elongate slot is parallel to the longitudinal axis of the nozzle.

Preferably, the nozzle is graduated on the side wall of the nozzle.

Preferably, the second tube is graduated on the side wall of the second tube.

Preferably, the nozzle is of a material selected from the group of: carbon fiber, fiberglass, and a carbon fiber and fiberglass composite.

Preferably, the carbon fiber and fiberglass composite consists of 50% carbon fiber and 50% fiberglass.

Preferably, the nozzle base has a nozzle base diameter greater than the diameter of the second tube, wherein the nozzle base comprises a spring loaded pin for securing the nozzle base to the upper end of the second tube.

Preferably, the nozzle tip has a nozzle tip diameter equal or smaller in diameter to the nozzle base diameter.

Preferably, the nozzle tip diameter is in the range of 60 mm to 120 mm.

Preferably, the upper end of the first tube comprises a locking pin for securing the upper end of the first tube to the lower end of the second tube.

Preferably, the handle portion comprises a telescopic handle member having a lower end and an upper end, wherein a handle is securable to the lower end of the telescopic handle member.

Preferably, the feeder pole further comprises an adaptor having a first aperture and an adjacent second aperture, wherein the first aperture is adapted to receive and secure the lower end of the first tube, and wherein the adjacent second aperture is adapted to receive and secure the upper end of the telescopic handle member.

Preferably, the diameter of the first aperture is greater than the diameter of the adjacent second aperture.

Preferably, the adaptor comprises a clamp for securing the telescopic handle member at a predetermined length.

Preferably, the handle comprises a nested spring mounted to a platform at one end of the spring and fastened within the lower end of the telescopic tubular handle member at the other end of the spring.

Preferably, the nested spring at the other end is fastened with stainless steel bolt and nut to the lower end of the telescopic tubular handle member.

Preferably, the tubular member has a first opening at the first end and a second opening at the second end, wherein the tubular member can receive a surveying apparatus therein from the first opening to the second opening.

Preferably, the surveying apparatus has a lower end and an upper end, wherein the lower end of the surveying apparatus is in connection with a rodder, wherein the rodder allows an operator to manoeuvre the upper end of the surveying apparatus out of the nozzle tip.

Preferably, the upper end of the surveying apparatus comprises a drill bit for drilling a hole to a predetermined depth.

Preferably, the rodder comprises a counterweight system.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

The present invention will now be described by way of example, with reference to the accompanying drawings, in which:

FIG. 1 is a side view of a nozzle 1 according to a preferred embodiment of the present invention.

FIG. 2A is a side view of an upper telescopic tube 2 according to a preferred embodiment of the present invention.

FIG. 2B is a side view of an upper telescopic tube 2 of FIG. 2 connected to a nozzle 1 of FIG. 1.

FIG. 3A is a combined bottom and side view of the lower feeder tube 3 according to a preferred embodiment of the present invention in use.

FIG. 3B is a combined bottom view of the lower feeder tube 3 with an adaptor.

FIG. 4A (top) is a side view of an assembled handle assembly; FIG. 4A (bottom) is a side view of the disassembled handle assembly of FIG. 4A (top).

FIG. 4B provides a cross-sectional view of the handle 4 with some diameter values for the tubing, according to a preferred embodiment of the present invention in use.

FIG. 5A is a side view of the assembled feeder pole 5 at full extension, according to a preferred embodiment of the present invention in use.

FIG. 5B is a side view of the disassembled feeder pole 5 at full extension of FIG. 5A.

FIG. 5C is a side view of the assembled feeder pole 5 showing indefinite length of the elongate tubes showing that the feeder tube can be used in a desired length.

FIG. 6 illustrates the practical configuration of the feeder pole 5 within a real-world field setting.

### DESCRIPTION OF THE INVENTION

A central feature of the invention is the feeder pole 5, which is a meticulously engineered apparatus designed to redefine the surveying landscape. This device comprises an upper telescopic tube 2, which is meticulously integrated with a tubed inlet known as the lower feeder tube 3. The purpose of this configuration is to seamlessly facilitate the insertion of a specialized gyro hole surveying instrument 6 or ‘Gyro’ 6.

The feeder pole 5 provides a seamless surveying workflow, in which this innovative approach significantly simplifies the surveying process. The user's engagement commences with assessing the elevation of the backs 9 in the underground environment. Subsequently, the users skillfully fine-tune the elevation of the lower feeder tube 3 by smoothly sliding it along the handle 4. The lower feeder tube 3 is securely locked into position when it attains a favourable working height.

The subsequent adjustment entails the upper telescopic tube 2, which is manipulated until the nozzle 1 seamlessly aligns with and is readily guided into the targeted blast hole 10. With the nozzle 1 properly inserted, the user can then exert downward pressure on the pogo stick 4.1, subsequently securing it firmly into position using the clamp 4.4. This procedure ensures stability and precise positioning.

The specialised gyro hole surveying instrument 6 or ‘Gyro’ 6 is introduced into the lower feeder tube 3. Through the controlled use of a purpose-designed rodder 8, the instrument is skillfully manoeuvered upwards by manually pushing fiberglass rod 7 within the feeder pole 5, transitioning from the lower feeder tube 3 to the upper telescopic tube 2. This orchestrated motion guides the ‘Gyro’ 6 along both feeder tubes, effectively directing its exit through the designated nozzle 1. This strategic positioning readies the ‘Gyro’ instrument 6 for seamless entry into the intended blast hole 10.

The feeder pole embodiment enables precise surveys in that the ‘Gyro’ instrument 6 allows easier access to the targeted blast hole 10. The Gyro hole surveying instrument 6 is strategically positioned to execute meticulous surveys within the confines of the blast hole 10. This procedure ensures the accurate collection and evaluation of vital surveying data.

In summation, the present invention pioneers an ingenious solution to the challenges of surveying upward-oriented holes in the realm of underground mining. The feeder pole 5 and its associated methodology eliminate the dependence on elevated work platforms, underscoring the efficiency and progressiveness inherent in this invention. By elegantly guiding the gyro hole surveying instrument ‘Gyro’ 6 through interconnected tubes and into the target blast hole 10, this invention offers a novel, accessible, and efficient pathway to comprehensive hole surveys.

Preferred embodiments of the invention will now be described with reference to the accompanying drawings and non-limiting examples.

The core design of the feeder pole 5 involves a precision-engineered nozzle 1 created to snugly fit within the collar of a designated blast hole 10. This blast hole 10 resides within the backs 9 of an underground tunnel, forming a crucial part of the mining operation.

Upon insertion of the nozzle 1 into the collar and ensuring alignment with the orientation of the blast hole 10, the functionality of the system unfolds. The clamp 4.4 is thoughtfully disengaged, allowing the telescopic extension of the handle 4. This motion carries the apparatus until it snugly meets the backs 9 of the tunnel. Supported by the pogo stick 4.1, the system is securely anchored into the tunnel floor. The process concludes by sealing the position with the clamp 4.4, affording steadfast stability to the feeder pole 5.

With the feeder pole 5 securely positioned both within the blast hole 10 and against the tunnel floor, the subsequent steps propel the feeder pole's 5 usability. The ‘Gyro’ 6 hole survey instrument is gently guided upward through the feeder pole 5. Elegantly emerging from the nozzle 1, the instrument 6 aligns itself with the collar of the blast hole 10. This configuration empowers operators to perform comprehensive surveys of the entire blast hole 10 from the ground level, marking a significant leap in surveying efficiency and safety.

The meticulous design of the feeder pole 5 has been guided by a dedicated emphasis on materials that strike a balance between lightweight construction and durability, ensuring resilience within the demanding underground environment.

An essential consideration is the challenging height of the backs 9, necessitating an innovative approach to functionality. To address this, the feeder pole 5 incorporates an extending capability, allowing it to reach distances that would otherwise pose ergonomic challenges.

In response to these requirements, the choice of materials becomes pivotal. Carbon fiber and fiberglass emerge as the prime constituents, artfully combined to form the structural core of this pioneering product. These materials not only guarantee the sought-after lightweight quality but also deliver the necessary robustness to withstand the rigorous conditions of the underground setting.

By thoughtfully integrating carbon fiber and fiberglass, the feeder pole 5 epitomizes the fusion of advanced materials science and inventive design, culminating in a feeder pole apparatus 5 capable of enduring the harshest conditions while facilitating seamless and efficient hole surveying operations.

A preferred embodiment of the present invention encompasses potential modifications and variations discernible to skilled individuals, enhancing its adaptability and utility.

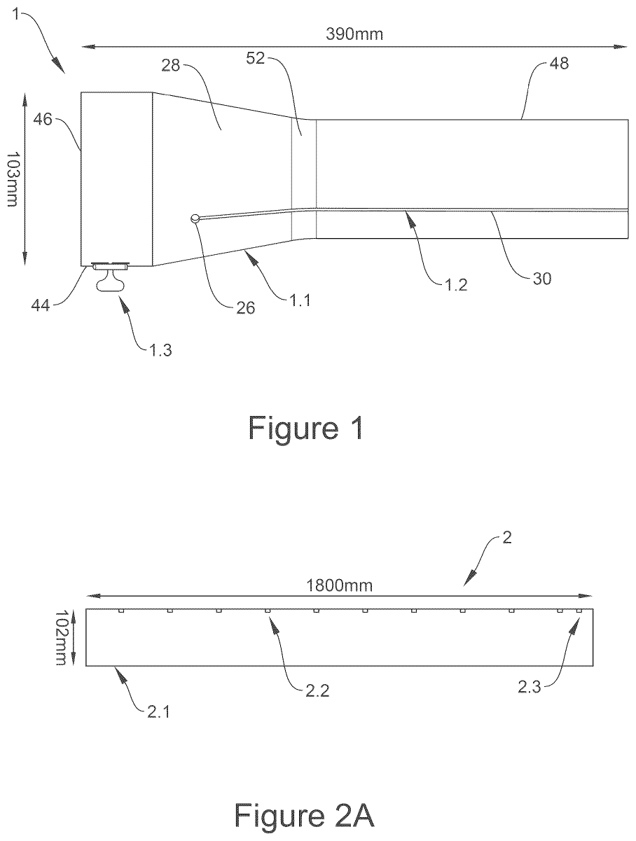

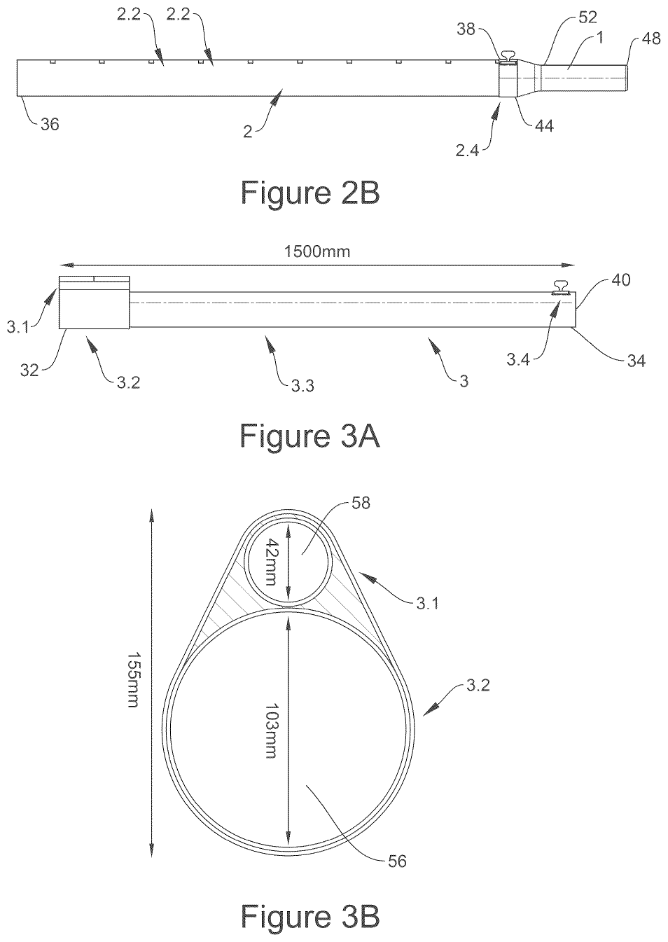

In an embodiment of the present invention, as illustrated in FIGS. 1 to 6, FIG. 5A shows a feeder pole apparatus 5 according to a preferred embodiment of the present invention. The feeder pole apparatus 5 for blast hole surveying, the feeder pole apparatus 5 may comprise an elongate member 20 or a first telescopic tubular member 20 which has a first end 22 and a second end 24. The first end 22 may be a lower end 22, and the second end 24 may be an upper end 24 when the elongate member 20 is vertical. The feeder pole 5 may have a handle portion 4 connectable to the tubular member 20 at the first end 22. FIG. 1 shows a nozzle 1 having a nozzle tip 48 and a nozzle base 44 with an opening 46, wherein the opening of the nozzle base is connectable to the tubular member 20 at the second end 24, as shown in FIG. 2B As shown in FIG. 1, the nozzle 1 may comprise a side wall aperture 26 positioned on a side wall 28 of the nozzle 1, and an elongate slot 30 joining the side wall aperture 26 to the nozzle tip 48.

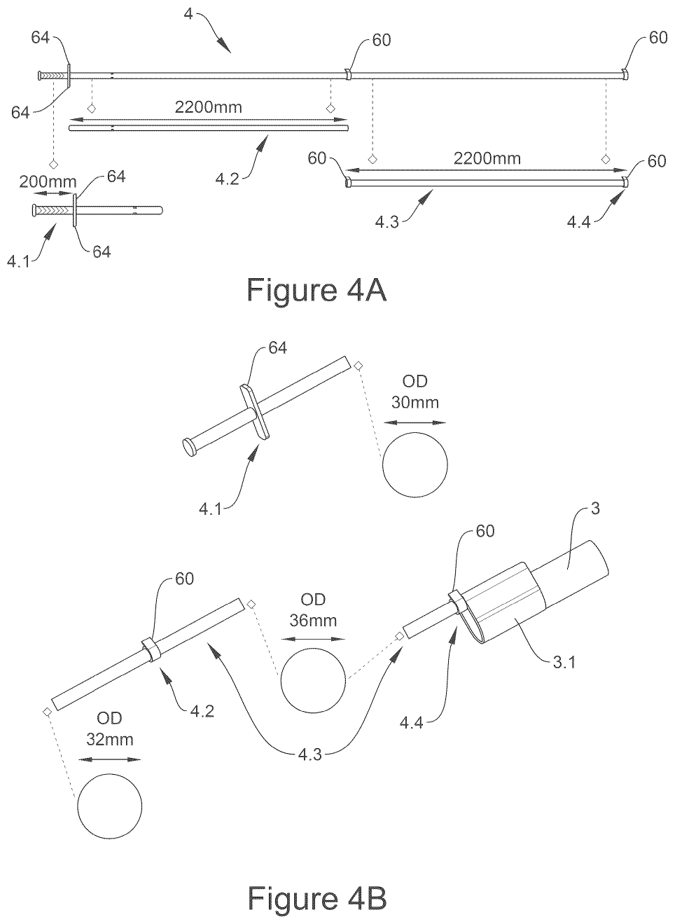

As shown in FIG. 3A, the tubular member 20 may comprise a first tube 3 or a lower feeder tube 3. The first tube 3 may have a predetermined length. The first tube's 3 length may be in the range between 1200 mm to 1800 mm. Most preferably, the length may be 1500 mm and the diameter of the first tube 3 may preferably be 103 mm. The first tube 3 may have a lower end 32 and an upper end 34 and the second tube 2 or upper telescopic tube 2 may also have a lower end 36 and an upper end 38. The first tube 3 may define a receiving space 40 from the lower end 32 and the upper end 34, and the second tube 2 may be receivable in the receiving space 40 of the first tube 3 in which the lower end 36 of the second tube 2 is securable to the upper end 34 of the first tube 3. The second tube's 2 length may be in the range of 1600 mm to 2600 mm. Most preferably, the length may be 1800 mm and the diameter of the second tube 2 may be 102 mm. The second tube may have length holes 2.2 along the side wall 44 of the second tube 2, and these length holes 2.2 may be equidistant with respect to the adjacent length hole 2.2. And these length holes may be 8 mm holes set 150 mm apart. These length holes 2.2 may be able to receive a lower locking pin 42 to lock into these holes 2.2 and it advantageously enable length adjustments by allowing access to the length holes 2.2 at different heights.

As illustrated in FIG. 2A, the upper end 38 of the second tube 2 may have a mounting hole 2.3 for a nozzle 1. The nozzle 1 may have a nozzle base 44 at one end 46 and a nozzle tip 48 at the other end 50. In one embodiment, the nozzle 1 is tubular with the nozzle base 44 and the nozzle tip 48 has the same diameter. In another preferred embodiment, the nozzle base 44 may be tapered to a middle portion 52 of the nozzle 1, in which the middle portion 52 is a nozzle portion between the nozzle base 44 and the nozzle tip 48, as shown in FIGS. 1, 2B, 5A to 5C, and 6.

As shown in FIG. 1, the side wall aperture 26 may be positioned on the nozzle 1 between the nozzle base 44 and the middle portion 52 of the nozzle 1, and the elongate slot 30 may be parallel to the longitudinal axis of the nozzle. The elongate slot 30 with the side wall aperture 26 may also be referred in this specification as ‘cut-out with hole’ 1.2, in which this ‘cut-out with hole’ 1.2 allows the nozzle 1 to compress when entering a hole which may be tightly fitting. By allowing the nozzle 1 to compress, it advantageously reduces the risk of damage to the nozzle 1. While a side view of the nozzle 1 is shown in FIG. 1, it may be appreciated that there are also two similar ‘cut-out with hole’ 1.2 (not shown) positioned equidistant around the side wall 28 of the nozzle 1 for flexibility and durability. Preferably, the cut-out or elongate slot 30 may be parallel to the longitudinal axis of the nozzle 1. The nozzle 1 may have a length of 390 mm and there may be four variants for blast hole sizing which may be 64 mm, 76 mm, 89 mm, and 102 mm. To assist the operator in determining blast hole depth, the nozzle 1 may optionally be graduated on the side wall 28 of the nozzle 1. As the blast holes may have differing depths, it may be appreciated that some blast holes may have a depth longer than the nozzle length. To accurately determine the depth of such deeper blast holes, the second tube 2 or upper telescopic elongate member 2 may also be graduated on the side wall 54 of the second tube 2.

For durability, robustness and flexible assistance in accessing holes for multiple applications, the nozzle 1 may be of a material selected from the group of: carbon fiber, fiberglass, and a carbon fiber and fiberglass composite. Depending on the applications, any of the listed materials can be preferably used. An advantage that carbon fibers offers is that it is exceptionally strong for its weight, making it an excellent choice for applications where high strength and low weight are crucial. It also has high stiffness so it's relatively more resistant to deformation under load, and it exhibits low thermal expansion and so making it suitable for applications where dimensional stability is important. An advantage that fiberglass offers is that fiberglass provides good tensile strength and slo allowing it to withstand pulling or stretching forces. In underground mining, the environment may have moisture and corrosive chemicals. Fiberglass is highly resistant to corrosion from these environmental factors. An advantage of using a material such as the carbon fiber and fiberglass composite is that it allows for a balance of properties of strength, stiffness, toughness and impact resistance from blasts. As fiberglass is generally less expensive than carbon fiber, it makes the composite more affordable while still providing excellent performance and creates a versatile, high-performance material suitable for blast hole surveying. Preferably, the carbon fiber and fiberglass composite may consist of 50% carbon fiber and 50% fiberglass.

The nozzle base 44 may have a nozzle base diameter 45 greater than the diameter of the second tube 2. The nozzle base 44 may comprise a spring loaded pin 1.3 to engage with the mounting hole 2.3 of the side wall of the second tube 2 near the second end or upper end. The spring loaded pin 1.3 may be used for locking on to the mounting hole for nozzle at the top of the upper tube or second tube 2. The spring loaded pin 1.3 may have a 8 mm×15 mm stem. The spring loaded pin 1.3 allows the advantageous use of the constant tension of the spring in trying to push the pin outwards therefore securing the nozzle to the second tube 2. As the nozzle tip 48 has an opening, the nozzle tip diameter 49 may be equal or smaller in diameter to the nozzle base diameter 45. In one embodiment where the nozzle base does not taper to a middle portion between the nozzle base and the nozzle tip, the nozzle tip diameter 49 may be equal. In another preferred embodiment where the nozzle base does taper to a middle portion between the nozzle base and the nozzle tip, the nozzle tip diameter 49 may be smaller in diameter to the nozzle base diameter. Preferably, the nozzle tip diameter is in the range of 60 mm to 120 mm. More preferably, the nozzle tip diameter may be chosen from any one of the following diameters of: 64 mm, 76 mm, 89 mm, and 102 mm. The longitudinal length of the nozzle 1 may be 390 mm with a base internal diameter of 103 mm.

In one embodiment, the tubular member may be an elongate tube with a first end and second end. In another embodiment, the tubular member may be telescopic to allow for advantageous adjustment of length. The first tube 3 or lower tube 3 may have a locking pin at the upper end. The locking pin can secure the upper end of the first tube to the lower end of the second tube 2. Depending on where the locking pin secures, the length can be adjusted.

To further provide adjustment to the length, the handle portion may comprise a telescopic handle member also having a lower end and an upper end. The handle is securable to the lower end of the telescopic handle member. To secure the handle portion adjacent to the lower end of the first tube 3, an adapter 3.1 may be used, as shown in FIG. 3B. The adapter 3.1 may have a first aperture 56 and an adjacent second aperture 58. The first aperture 56 may be adapted to receive and secure the lower end of the first tube 3, and the adjacent second aperture 58 may be adapted to receive and secure the upper end of the telescopic handle member. The diameter of the first aperture 56 may be greater than the diameter of the adjacent second aperture 58.

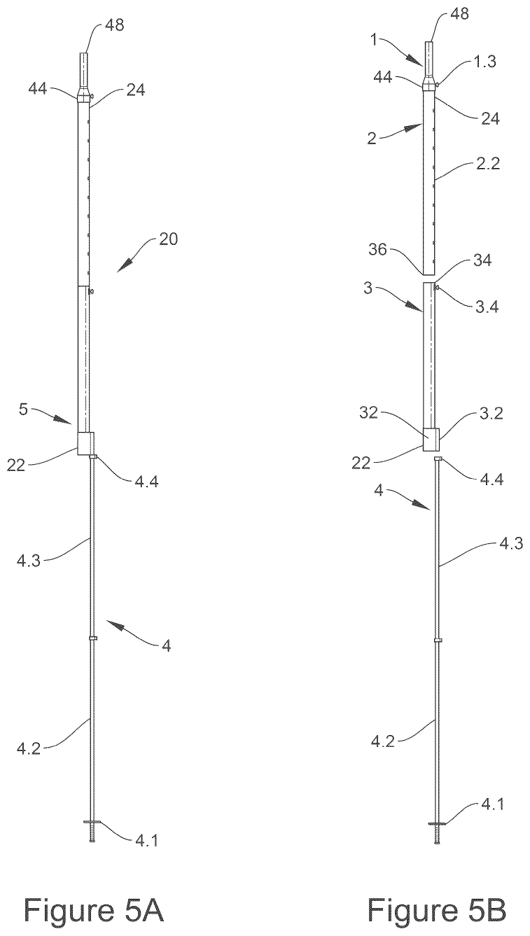

The adaptor 3.1 may be of a material that is a heavy-duty woven fiberglass or carbon fiber wrap to secure the adaptor 3.1 to the lower end of the first tube 3. As shown in FIG. 4B, the adaptor 3.1 may comprise a clamp 60 for securing the telescopic handle member at a predetermined length in consideration with the predetermined length of the tubular member.

The handle portion may comprise a nested spring 62 mounted to a platform 64 at one end of the spring 66 and fastened within the lower end of the telescopic tubular handle member at the other end of the spring 68 (not shown). The nested spring 62 at the other end 68 may be fastenable with a stainless steel bolt and nut to the lower end of the telescopic tubular handle member.

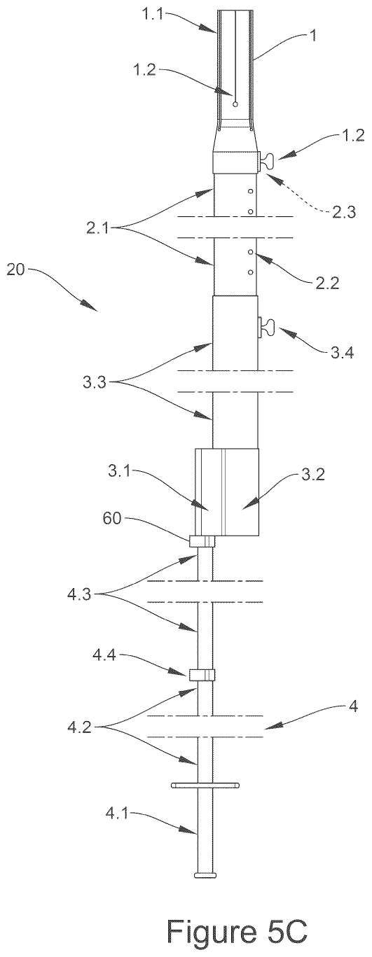

As shown in FIGS. 5A to 5C, as the tubular member or telescopic tubular member has a first opening at the first end and a second opening at the second end, wherein the tubular member can receive a surveying apparatus 6 therein from the first opening to the second opening. The surveying apparatus 6 may have a lower end 70 and an upper end 72, wherein the lower end 70 of the surveying apparatus 6 is in connection with a rodder 8, wherein the rodder 8 allows an operator to manually manoeuvre the upper end 72 of the surveying apparatus out of the nozzle tip. For when the blast hole 10 is surveyed to be too shallow, the surveying apparatus may have a drill bit at the upper end (not shown). The drill bit may be for drilling a hole to a predetermined depth. As the feeder pole apparatus can be heavy, it is preferable to have the rodder 8 having a counterweight system 74 to prevent the feeder pole apparatus from tipping over. The counterweight system 74 may be a mechanism designed to provide balance and stability to the rodder 8 during surveying and/or drilling operations. It typically consists of a weight attached to the rodder 8, usually at a point above the drilling bit. The advantageous purpose of using a counterweight system is to offset the weight of the drill bit and maintain consistent pressure on the bit while drilling. This helps to ensure that the drill bit maintains its intended trajectory and depth throughout the drilling process. The counterweight system enhances the stability of the rodder 8, reducing the likelihood of erratic movement or vibration during drilling and/or surveying and it helps maintain a consistent drilling depth and angle, which is crucial for achieving accurate results, especially in precision drilling applications. Depending on the specific drilling and surveying conditions, the counterweight system may be adjustable. This allows the operators to fine-tune the balance and pressure exerted on the drill bit, ensuring optimal performance.

An example process for using the feeder pole apparatus may be before drilling, the feeder pole is used to measure the depth of the blast hole 10. This information is crucial for planning the drilling operation and determining the appropriate length of rodder 8 needed. The rodder is attached to the drill string 7 and the surveying apparatus 6 inserted into the hole. The feeder pole is introduced into the hole to verify and record the final depth. The surveyor reads the depth measurement from the feeder pole, and to determine whether that the drilled hole or the hole has reached the intended depth. By using the feeder pole in conjunction with the rodder 8, surveyors can accurately measure the depth of drilled holes both before and after the drilling process. This ensures that the holes are drilled to the required specifications, contributing to the safety and efficiency of blasting operations in mining and construction projects. The fiberglass rodder 8 is an essential tool utilized in underground mining operations to facilitate the deployment of a north-seeking gyro 6 up a feeder pole 5. This gyro instrument 6, once positioned within the drill hole 10, allows for accurate surveying of the hole's orientation and depth. The following technical description will outline the components and mechanisms of the fiberglass rodder 8, its stability features, and the functionality of the gyro system.

The fiberglass rodder 8 is designed to ensure stability on the often uneven and challenging terrain of underground mining conditions. Its key stabilization features may comprise: a low-profile frame design, where the rodder 8 features a tightly built frame that is designed to be as close to the ground as possible. This design enhances stability by lowering the center of gravity and advantageously reduces the risk of tipping over during operation. It may further comprise a wheeled base, where the rodder 8 may be equipped with wheels that may allow for ease of movement across rough floor surfaces. These wheels may advantageously withstand the harsh conditions commonly found in mining environments, providing both mobility and stability. The stabilization feature may further comprise an adjustable arm, where the rodder 8 may include an adjustable arm mechanism that allows operators to modify the angle of entry into the feeder pole. This adjustability ensures that the rodder 8 can be precisely positioned and used together with the feeder pole 5 for efficient gyro deployment, and aligning with the variable entry angles of feeder pole telescopic tubes 2, 3.

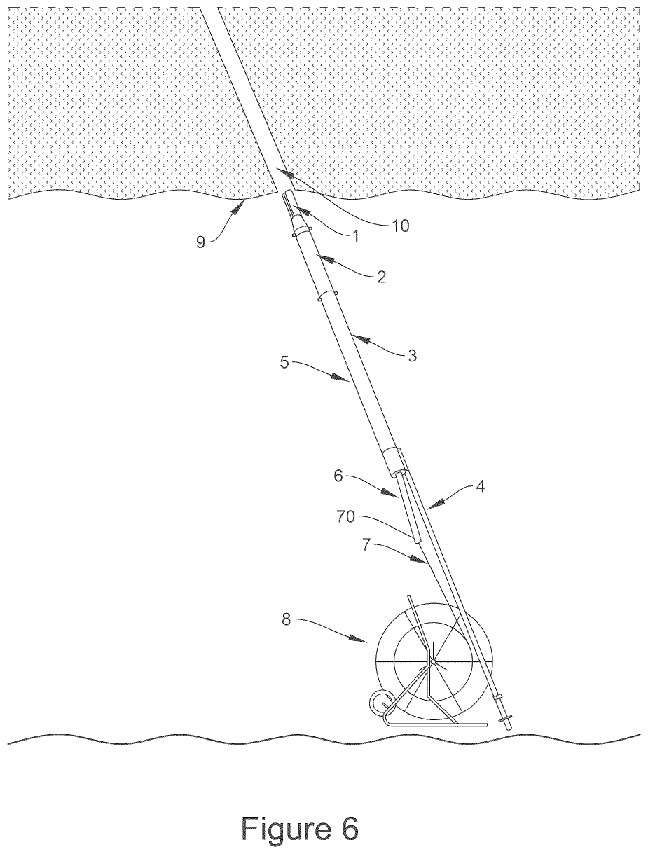

The fiberglass rodder 8 may comprise several preferable or critical mechanisms that enable its operation in pushing the gyro instrument 6 up the feeder pole 5. As shown in FIG. 6, there is a fiberglass rod 7 which is advantageously designed to be rigid and resilient, and capable of withstanding significant push and pull forces without deformation. The north-seeking gyro instrument 6 is securely attached to the fiberglass rod 7 using epoxy glue. This epoxy adhesive may be chosen for its exceptional strength, ensuring that the gyro instrument 6 remains firmly connected to the rod 7 at the lower end 70 of the surveying apparatus or gyro instrument 6 even when subjected to substantial forces during operation. The mechanism may further comprise an encoder wheel integrated along the length of the rodder 8. As the fiberglass rod 7 is pushed or pulled, it passes through this wheel. The encoder may be advantageously responsible for accurately counting the distance the gyro travels up the hole 10. This distance measurement is critical for surveying and calculating the hole's depth and deviation. Further, the gyro's functionality is a crucial component of the surveying system as it is equipped with sensors and mechanisms that enable it to determine true north. This capability is essential for accurately assessing the orientation of the drill hole. The gyro system may include a timestamp feature. As the gyro ascends or descends the hole, it records the time at various positions. This timestamp data is matched with the distance data obtained from the encoder wheel to calculate the length and deviation of the hole. As such the fiberglass rodder 8 serves as the vehicle for deploying the north-seeking gyro up feeder poles 5 in underground mining operations. It provides stability on challenging terrains, utilises a sturdy fiberglass rod 7, employs strong epoxy glue connections, incorporates an encoder wheel for distance measurement, and works in conjunction with a gyro system to accurately survey drill holes 10, and providing critical data for mining operations.

The manufacture of the feeder pole apparatus may involve several steps, from selecting the right materials to finishing the product. Depending on the application, the appropriate material for the feeder pole apparatus can be based on factors such as durability, weight, and environmental considerations. Carbon fiber or reinforced fiberglass and/or a composite may be preferably used. The elongate tubular members may have a predetermined length, a predetermined diameter and any specific features such as graduations for depth measurement on the side of the tube to allow an operator to know how deep a hole or a blast hole may be when surveying. For cutting and shaping the feeder pole apparatus, cutting tools, such as saws or Computer numerical control (CNC) machines may be used. The CNC machine may be a device allowing for a manufacturing method that automates the control, movement, and precision of machine tools through the use of preprogramed computer software, which may be embedded inside the tools. Precise measuring tools may be used to mark and engrave them along the length of the pole. Depending on the use, the feeder pole may a have a finishing on the external surface of the apparatus. For high moisture environments, a corrosion resistance material may be used. As the feeder pole apparatus may include multiple components such as telescopic sections and length holes and fasteners to allow an operator to adjust the feeder pole apparatus to a predetermined length for use, these parts can be assembled according to the design specifications. As this apparatus may be used in a high-risk environment, quality control of the apparatus is important as each feeder pole is inspected to ensure it meets the specified dimensions, markings/graduations, and quality standards. As there may be different sized blast holes, the feeder pole may have a appropriate markings and dimensions so that the feeder pole apparatus can be carefully chosen for the specific surveying and task. Further, additional tests may be conducted such as load testing or stress testing to ensure that the feeder pole apparatus can meet specific performance criteria. Similarly, these manufacturing steps can be applied to the fiberglass nozzle part and the handle portion and their telescopic parts.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A feeder pole apparatus for blast hole surveying, the feeder pole comprising:
a tubular member having a first end and a second end;
a handle portion connectable to the tubular member adjacent to the first end;
a nozzle having a tip and a base with an opening, wherein the opening of the base is connectable to the second end of the tubular member;
the nozzle comprising a side wall aperture positioned on a side wall of the nozzle, and an elongate slot joining the side wall aperture to the nozzle tip.

2. The feeder pole apparatus according to claim 1, wherein the tubular member comprises a first tube having a lower end and an upper end, and a second tube having a lower end and an upper end, wherein the first tube defines a receiving space from the lower end to the upper end; the second tube receivable in the receiving space of the first tube, wherein the lower end of the second tube is securable to the upper end of the first tube.

3. The feeder pole apparatus according to claim 2, wherein the nozzle has a nozzle base at one end and a nozzle tip at the other end, wherein the nozzle base is secured to the upper end of the second tube.

4. The feeder pole apparatus according to claim 3, wherein the nozzle base tapers to a middle portion between the nozzle base and the nozzle tip.

5. The feeder pole apparatus according to claim 4, wherein the side wall aperture is positioned between the nozzle base and the middle portion of the nozzle.

6. The feeder pole apparatus according to claim 1, wherein the elongate slot is parallel to a longitudinal axis of the nozzle.

7. The feeder pole apparatus according to claim 1, wherein the nozzle is graduated on the side wall of the nozzle.

8. The feeder pole apparatus according to claim 7, wherein the tubular member comprises a first tube having a lower end and an upper end, and a second tube having a lower end and an upper end; wherein the second tube is graduated on the side wall of the second tube.

9. The feeder pole apparatus according to claim wherein the nozzle is of a material selected from the group of: carbon fiber, fiberglass, and a carbon fiber and fiberglass composite.

10. The feeder pole apparatus according to claim 9, wherein the carbon fiber and fiberglass composite consists of 50% carbon fiber and 50% fiberglass.

11. The feeder pole apparatus according to claim 2, wherein the nozzle base has a nozzle base diameter greater than the diameter of the second tube, wherein the nozzle base comprises a spring loaded pin for securing the nozzle base to the upper end of the second tube.

12. The feeder pole apparatus according to claim 11, wherein the nozzle tip has a nozzle tip diameter equal or smaller in diameter to the nozzle base diameter.

13. The feeder pole apparatus according to claim 12, wherein the nozzle tip diameter is in a range of 60 mm to 120 mm.

14. The feeder pole apparatus according to claim 2, wherein the upper end of the first tube comprises a locking pin for securing the upper end of the first tube to the lower end of the second tube.

15. The feeder pole apparatus according to claim 1, 14, wherein the handle portion comprises a telescopic handle member having a lower end and an upper end, wherein a handle is securable to the lower end of the telescopic handle member.

16. The feeder pole apparatus according to claim 15, further comprising an adaptor having a first aperture and an adjacent second aperture, wherein the first aperture is adapted to receive and secure the lower end of first tube of the tubular member, and wherein the adjacent second aperture is adapted to receive and secure the upper end of the telescopic handle member.

17. The feeder pole apparatus according to claim 16, wherein diameter of the first aperture is greater than the diameter of the adjacent second aperture.

18. The feeder pole apparatus according to claim 16, wherein the adaptor comprises a clamp for securing the telescopic handle member at a predetermined length.

19. The feeder pole apparatus according to claim 15, wherein the handle comprises a nested spring mounted to a platform at one end of the spring and fastened within the lower end of the telescopic tubular handle member at the other end of the spring.

20. The feeder pole apparatus according to claim 19, wherein the nested spring at the other end is fastened with stainless steel bolt and nut to the lower end of the telescopic tubular handle member.

21. The feeder pole apparatus according to claim 1, wherein the tubular member has a first opening at the first end and a second opening at the second end, wherein the tubular member can receive a surveying apparatus therein from the first opening to the second opening.

22. The feeder pole apparatus according to claim 21, wherein the surveying apparatus has a lower end and an upper end, wherein the lower end of the surveying apparatus is in connection with a rodder, wherein the rodder allows an operator to manoeuvre the upper end of the surveying apparatus out of the nozzle tip.

23. The feeder pole apparatus according to claim 22, wherein the upper end of the surveying apparatus comprises a drill bit for drilling a hole to a predetermined depth.

24. The feeder pole apparatus according to claim 23, wherein the rodder comprises a counterweight system.
